(19) United States
(12) Patent Application Publication
(10) Pub. No.: US 2011/0235910 A1
(43) Pub. Date: Sep. 29, 2011

(54) METHOD CIRCUIT AND SYSTEM FOR MATCHING AN OBJECT OR PERSON PRESENT WITHIN TWO OR MORE IMAGES

(76) Inventors: Omri Soceanu, Haifa (IL); Guy Berdugo, Kiryat-Motzkin (IL); Yair Moshe, Haifa (IL); Dmitry Rudoy, Haifa (IL); Itsik Dvir, Haifa (IL); Dan Raudnitz, Hod-Hasharon (IL)

(21) Appl. No.: 13/001,631

(22) PCT Filed: Jun. 30, 2010
(86) PCT No.: PCT/IB10/53008

§ 371 Date: Jun. 12, 2011

Related U.S. Application Data
(60) Provisional application No. 61/221,719, filed on Jun. 30, 2009.
(60) Provisional application No. 61/222,939, filed on Jul. 3, 2009.

(51) Int. Cl. G06K 9/46; G06K 9/34

(52) U.S. Cl. 382/173; 382/190

(57) ABSTRACT

Disclosed is a system and method for image processing and image subject matching. A circuit and system may be used for matching/correlating an object/subject or person present (i.e. visible within) within two or more images. An object or person present within a first image or a first series of images (e.g. a video sequence) may be characterized and the characterization information (i.e. one or a set of parameters) relating to the person or object may be stored in a database, random access memory or cache for subsequent comparison to characterization information derived from other images.

### FIELD OF THE INVENTION

The present invention relates generally to the field of image processing. More specifically, the present invention relates to a method, circuit and system for correlating/matching an object or person present (subject of interest) visible within two or more images.

### BACKGROUND

Today's object retrieval and re-identification algorithms often provide inadequate results due to: different lightning conditions, times of the day, weather and so on; different viewing angles: multiple cameras with overlapping or non-overlapping fields of view; unexpected trajectories of the objects: people changing paths, not walking in the shortest path possible; unknown entry points: objects may enter the field of view from any point; and for additional reasons. Accordingly, remains a need in the field of image processing for improved object retrieval circuits, systems, algorithms and methods.

The following listed publications address various aspects of image subject processing and matching, and their teachings are hereby incorporated into the present application by reference in their entirety.

[1] T. B. Moeslund, A. Hilton, and V. Krüger, “A survey of advances in vision-based human motion capture and analysis,” Computer Vision and Image Understanding, vol. 104, no. 2-3, pp. 90-126, November 2006.

[2] A. Colombo, J. Orwell, and S. Velastin, “Colour constancy techniques for re-recognition of pedestrians from multiple surveillance cameras,” in Workshop on Multi-camera and Multi-modal Sensor Fusion Algorithms and Applications (M2SFA2 2008), October 2008, Marseille, France.

[3] K. Jeong, C. Jaynes, “Object matching in disjoint cameras using a color transfer approach,” Special Issue of Machine Vision and Applications Journal, vol. 19, pp 5-6, October 2008.

[4] F. M. Porikli, A. Divakaran, “Multi-camera calibration, object tracking and query generation,” in Proc. IEEE Int. Conf. Multimedia and Expo, Baltimore, Md., Jul. 6-9, 2003, vol. 1, pp. 653-656.

[5] O. Javed, K. Shafique, M. Shah, “Appearance modeling for tracking in multiple non-overlapping cameras,” in IEEE Computer Society Conference on Computer Vision and Pattern Recognition, Jun. 20-25, 2005, vol. 2, pp 26-33.

[6] V. Modi, “Color descriptors from compressed images”, in CVonline: The Evolving, Distributed, Non-Proprietary, On-Line Compendium of Computer Vision. Retrieved Dec. 30, 2008

[7] C. Madden, E. D. Cheng, M. Piccardi, “Tracking people across disjoint camera views by an illumination-tolerant appearance representation” in Machine Vision and Applications, vol. 18, pp 233-247, 2007.

[8] S. Y. Chien, W. K. Chan, D. C. Cherng, J. Y. Chang, “Human object tracking algorithm with human color structure descriptor for video surveillance systems,” in Proc. of 2006 IEEE International Conference on Multimedia and Expo, Toronto, Canada, July 2006, pp. 2097-2100.

[9] Z. Lin, L. S. Davis, “Learning pairwise dissimilarity profiles for appearance recognition in visual surveillance,” in Proc. of the 4th International Symposium on Advances in Visual Computing, Lecture Notes in Computer Science, Vol. 5358, pp. 23-24, 2008.

[10] C. Bishop, Pattern recognition and machine learning. New York: Springer, 2006.

[11] O. Soceanu, G. Berdugo, D. Rudoy, Y. Moshe, I. Dvir, “Where's Waldo? Human figure segmentation using saliency maps,” in Proc. ISCCSP 2010, Limassol, Cyprus, Mar. 3-5, 2010.

[12] T. B. Moeslund, A. Hilton, and V. Kruger, “A survey of advances in vision-based human motion capture and analysis” Computer Vision and Image Understanding, vol. 104, no. 2-3, pp. 90-126, November 2006.

[13] Y. Yu, D. Harwood, K. Yoon, and L. S. Davis, “Human appearance modelling for matching across video sequences,” in Machine Vision and Applications, vol. 18, no. 3-4, pp. 139-149, August 2007.

[14] N. Dalal and B. Triggs, “Histograms of oriented gradients for human detection,” in Proc. International Conference on Computer Vision, Beijing, China, Oct. 17-21, 2005, pp. 886-893.

[15] S. Kullback, Information Theory and Statistics. John Wiley & Sons, 1959.

### SUMMARY OF THE INVENTION

The present invention is a method, circuit and system for correlating an object or person present (i.e. visible within) within two or more images. According to some embodiments of the present invention, an object or person present within a first image or a first series of images (e.g. a video sequence) may be characterized and the characterization information (i.e. one or a set of parameters) relating to the person or object may be stored in a database, random access memory or cache for subsequent comparison to characterization information derived from other images. Database may also be distributed over the net of storage locations.

According to some embodiments of the present invention, characterization of objects/persons found within an image may be performed in two stages: (1) segmentation, and (2) feature extraction.

According to some embodiments of the present invention, an image subject matching system may include a feature extraction block for extracting one or more features associated with each of one or more subjects in a first image frame, wherein feature extraction may include generating at least one ranked oriented gradient. The ranked oriented gradient may be computed using numerical processing of pixel values along a horizontal direction. The ranked oriented gradient may be computed using numerical processing of pixel values along a vertical direction. The ranked oriented gradient may be computed using numerical processing of pixel value along both horizontal and vertical directions. The ranked oriented gradient may be associated with a normalized height. The ranked oriented gradient of an image feature may be compared against a ranked oriented gradient of a feature in a second image.

According to further embodiments of the present invention, an image subject matching system may include a feature extraction block for extracting one or more features associated with each of one or more subjects in a first image frame, wherein feature extraction may include computing at least one ranked color ratio vector. The vector may be computed using numerical processing of pixels along a horizontal direction. The vector may be computed using numerical processing of pixel values along a vertical direction. The vector may be computed using numerical processing of pixel values along both horizontal and vertical directions. The vector may be associated with a normalized height. The vector of an image feature may be compared against a vector of a feature in a second image.

According to some embodiments, there is provided an image subject matching system including an object detection block or an image segmentation block for segmenting an image into one or more image segments containing a subject of interest, wherein object detection or image segmentation may include generating at least one saliency map. The saliency map may be a ranked saliency map.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying appendixes in which:

FIG. 1A is a block diagram of an exemplary system for correlating an object or person (e.g. subject of interest) present within two or more images, in accordance with some embodiments of the present invention;

FIG. 1B is a block diagram of an exemplary Image Feature Extraction & Ranking/Normalization Block, in accordance with some embodiments of the present invention;

FIG. 1C is a block diagram of an exemplary Matching Block, in accordance with some embodiments of the present invention;

FIG. 2 is a flow chart showing steps performed by an exemplary system for correlating/matching an object or person present within two or more images, in accordance with some embodiments of the present invention;

FIG. 3 is a flow chart showing steps of an exemplary saliency map generation process which may be performed as part of Detection and/or Segmentation in accordance with some embodiments of the present invention;

FIG. 4 is a flow chart showing steps of an exemplary background subtraction process which may be performed as part of Detection and/or Segmentation in accordance with some embodiments of the present invention;

FIG. 5 is a flow chart showing steps of an exemplary color ranking process which may performed as part of color features extraction in accordance with some embodiments of the present invention;

FIG. 6A is a flow chart showing steps of an exemplary color ratio ranking process which may be performed as part of a textural features extraction in accordance with some embodiments of the present invention;

FIG. 6B is a flow chart showing steps of an exemplary oriented gradients ranking process which may be performed as part of a textural features extraction in accordance with some embodiments of the present invention;

FIG. 6C is a flow chart showing the of an exemplary saliency maps ranking process which may be performed as part of textural features extraction in accordance with some embodiments of the present invention;

FIG. 7 is a flow chart showing steps of an exemplary height features extraction process which may be performed as part of textural features extraction in accordance with some embodiments of the present invention;

FIG. 8 is a flow chart showing steps of an exemplary characterization parameters probabilistic modeling process in accordance with some embodiments of the present invention;

FIG. 9 is a flow chart showing steps of an exemplary distance measuring process which may be performed as part of a feature matching in accordance with some embodiments of the present invention;

FIG. 10 is a flow chart showing steps of an exemplary database referencing and match decision process which may be performed as part of feature and/or subject matching in accordance with some embodiments of the present invention;

FIG. 11A is a set of image frames containing human subject, before and after a background removal process, in accordance with some embodiments of the present invention;

FIG. 11B is a set of image frames showing images containing a human subjects after: (a) a segmentation process; (b) a color ranking process; (c) a color ratio extraction process; (d) a gradient orientation process; and (e) a saliency maps ranking process, in accordance with some embodiments of the present invention;

FIG. 11C is a set of image frames showing human subjects having similar color schemes but which may be differentiated by their shirts' patterns in accordance with some embodiments of the present invention; and

FIG. 12 is a table comparing exemplary human reidentification success rate results between exemplary reidentification methods of the present invention and those taught by Lin et al., when using one or two cameras, and in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a method, circuit and system for correlating an object or person present (i.e. visible within) within two or more images. According to some embodiments of the present invention, an object or person present within a first image or a first series of images (e.g. a video sequence) may be characterized and the characterization information (i.e. one or a set of parameters) relating to the person or object may be stored in a database, random access memory or cache for subsequent comparison to characterization information derived from other images. Database may also be distributed over the net of storage locations.

According to some embodiments of the present invention, characterization of objects/persons found within an image may be performed in two stages: (1) segmentation, and (2) feature extraction.

According to some embodiments of the present invention, Segmentation may be performed using any technique known today or to be devised in the future. According to some embodiments Background, Subtraction techniques (e.g. using a reference image) or other object detection techniques (without reference image, e.g. Viola and Jones) may be used for initial, rough segmentation of objects. Another technique, which may also be used as a refinement technique, may include the use of a saliency map(s) of the object/person. There are several ways in which saliency maps may be extracted.

According to some embodiments of the present invention, saliency mapping may include transformation of the image I(x,y) to the frequency and phase domain, A(kx,ky) exp(jΦ(kx,ky)=F{I(x,y)}. F indicates the 2-D spatial Fourier transform, where A and Φ is the amplitude and the phase of the transformation, respectively. The saliency maps may be obtained as S(x,y)=g*|F−1{1/A exp(jΦ)}|̂2. Where F−1 indicates the inverse of the 2-D spatial Fourier transform, g is a 2D Gaussian function, ∥ and * indicates absolute value and convolution, respectively. According to further embodiments of the present invention, saliency maps may be else wise obtained (e.g. as S(x,y)=g*|F−1{exp(jΦ)}|̂2 (Guo C. et at, 2008)).

According to some embodiments of the present invention, various characteristics such as color, textural and spatial features may be extracted from the segmented object/person. According to some embodiments of the present invention, features may be extracted for comparison between objects. Features may be made compact for storage efficiency (e.g. Mean Color, Most Common Color, 15 Major Colors). While some features such as color histogram and oriented gradients histogram may contain probabilistic information, others may contain spatial information.

According to some embodiments of the present invention, certain considerations may be made when choosing the features to be extracted from the segmented object. Such considerations may include: the discriminative nature and the separability of the feature, the robustness to illumination changes when dealing with multiple cameras and dynamic environments, and, noise robustness and scale invariance.

According to some embodiments of the present invention, scale invariance may be achieved by resizing each figure to a constant size. Robustness to illumination changes may be achieved using a method of ranking over the features, mapping absolute values to relative values. Ranking may cancel any linear modeled lighting transformations, under the assumption that for such transformations the shape of the feature distribution function is relatively constant. According to some embodiments, in order to obtain the rank of a vector x, the normalized cumulative histogram H(x) of the vector is calculated. The rank O(x) is may accordingly be given by: O(x)=┌H(x)·100┐

Where [symbol] denotes rounding the number up to the consecutive integer. For example, using 100 as a factor sets the possible values of the ranked feature to [symbol] and sets the values of O(x) to the percentage values of the cumulative histogram. The proposed ranking method may be applied on the chosen features to achieve robustness to linear illumination changes.

According to some embodiments of the present invention, color rank features (Yu Y et. al, 2007) may be used. Color rank values may be obtained by applying the ranking process on the RGB color channels using the O(x)=┌H(x)·100┐ equation.

Another color feature is the normalized color, this feature's values are obtained using the following color transformation:

$$( r , g , s ) = ( \frac{R}{( R + G + B )} , \frac{G}{( R + G + B )} , \frac{( R + G + B )}{3} )$$

Where R, G and B denote the red, green and blue color channels of the segmented object, respectively. r and g denote the chromaticity of the red and green channel respectively and s denotes the brightness. Transforming to the rgs color space may separate the chromaticity from the brightness resulting in illumination invariance.

According to some embodiments of the present invention, when dealing with similarly colored objects or with figures with similar clothing colors (e.g. a red and white striped shirt compared with a red and white shirt with a crisscross pattern) color ranking may be insufficient. Textural features, on the other hand, may obtain values in relation to their spatial surroundings as Information is extracted from a region rather than a single pixel and thus a more global point of view is obtained.

According to some embodiments of the present invention, a ranked color ratio feature, in which each pixel is divided by its neighbor (e.g. upper), may be obtained. This feature is derived from a multiplicative model of light and a principle of locality. This operation may intensify edges and may separate them from the plain regions of the object. For a more compact representation, as well as rotational invariance around the vertical axis, an average may be calculated over each row. This may result in a column vector corresponding to the spatial location of each value. Finally, the resulting vector or matrix may be ranked by applying the O(x)=┌H(x)·100┐ equation.

According to some embodiments of the present invention, Oriented Gradients Rank may be computed using numerical derivation on both horizontal (dx) and vertical (dy) directions. The ranking of orientation angles may be executed as described hereinbefore. According to some embodiments of the present invention, the Ranked Oriented Gradients may be based on a Histogram of Oriented Gradients. According to some embodiments, a 1-D centered mask may initially be applied (e.g. −1,0,1) on both horizontal and vertical directions.

According to some embodiments of the present invention, Ranked Saliency Maps, may be obtained by extracting one or more textural features where a textual feature may be extracted from a saliency map S(x,y) (e.g. the map described hereinbefore). The values of S(x,y) may be ranked and quantized.

According to some embodiments of the present invention, in order to represent the aforementioned features in a structural context, spatial information may be stored by using a height feature. The height feature may be calculated using the normalized y-coordinate of the pixel, wherein the normalization may ensure scale invariance, using the normalized distance from the location of the pixel on the grid of data samples to the top of the object. The normalization may be done with respect to the object's height.

According to some embodiments of the present invention, matching or correlating the same objects/people found in two or more images may be achieved by matching characterization parameters of the objects/people extracted from each of the two or more images. Each of a wide variety of parameter(s) (i.e. data set) matching algorithms may be utilized as part of the present invention.

According to some embodiments of the present invention, a distance between the characterization parameter set of an object/person found in an acquired image and each of multiple characterization sets stored in a database may be calculated when attempting to correlate the object/person with previously imaged objects/people. The distance values from each comparison may be used to assign one or more rankings for probability of a match between objects/people. According to some embodiments of the present invention, the shorter the distance is, the higher the ranking may be.

According to some embodiments of the present invention, a ranking resulting from a comparison of two object/person images having a value above some predefined or dynamically selected threshold may be designated as a “match” between the objects/persons/subjects found in the two images.

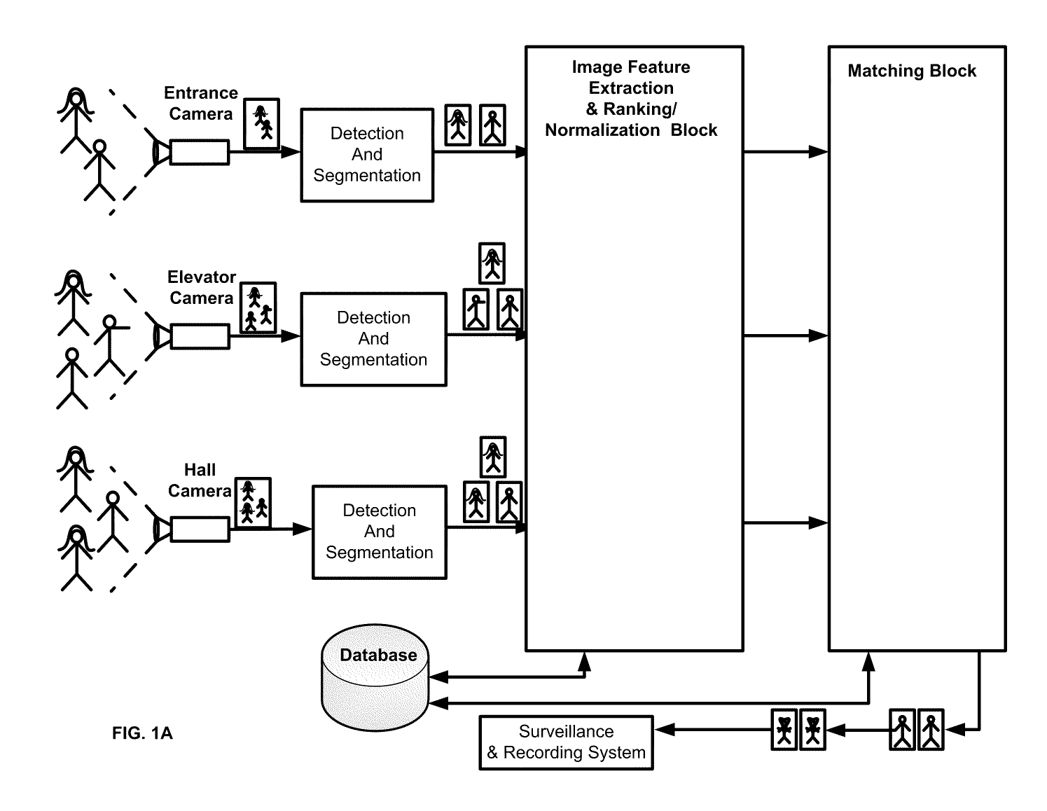

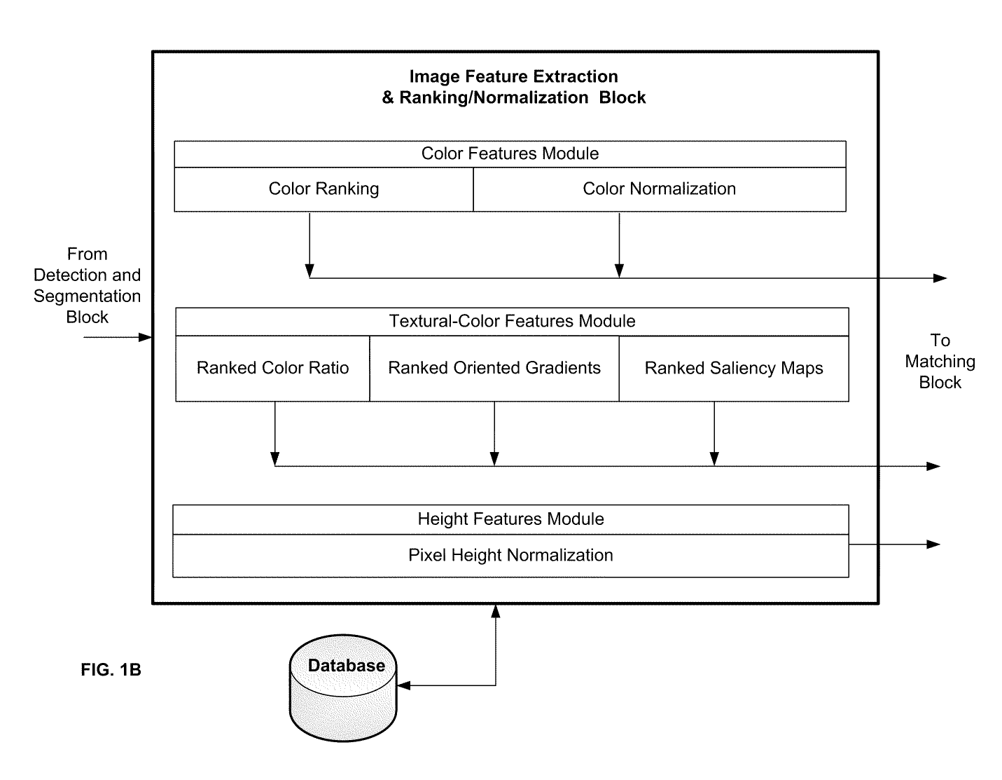

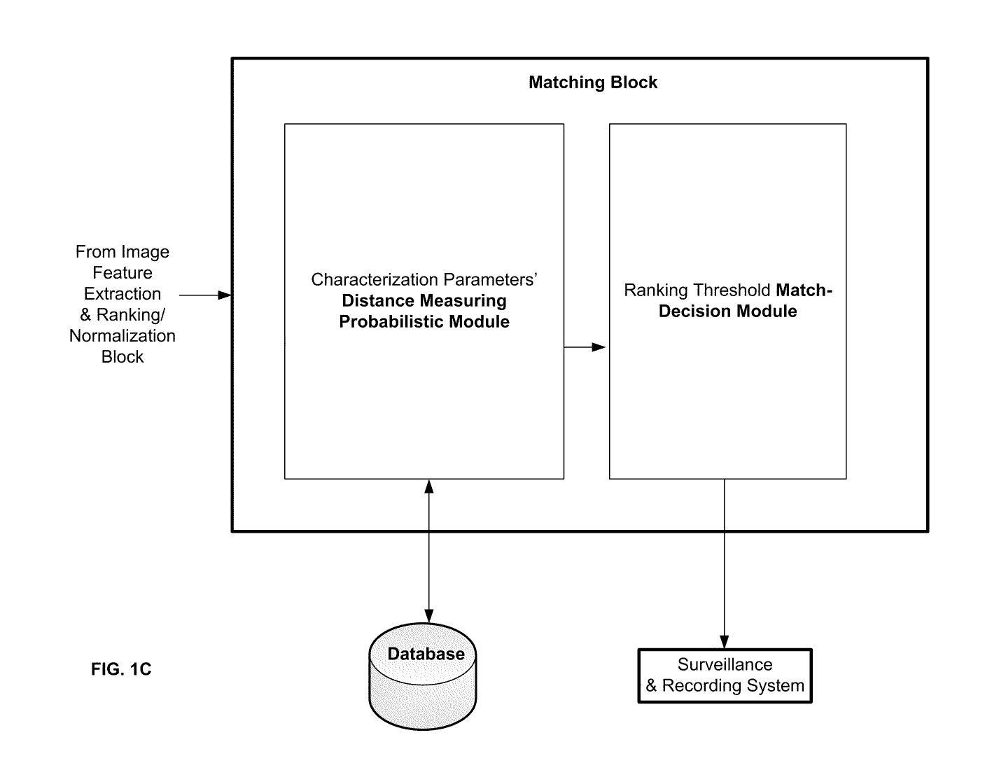

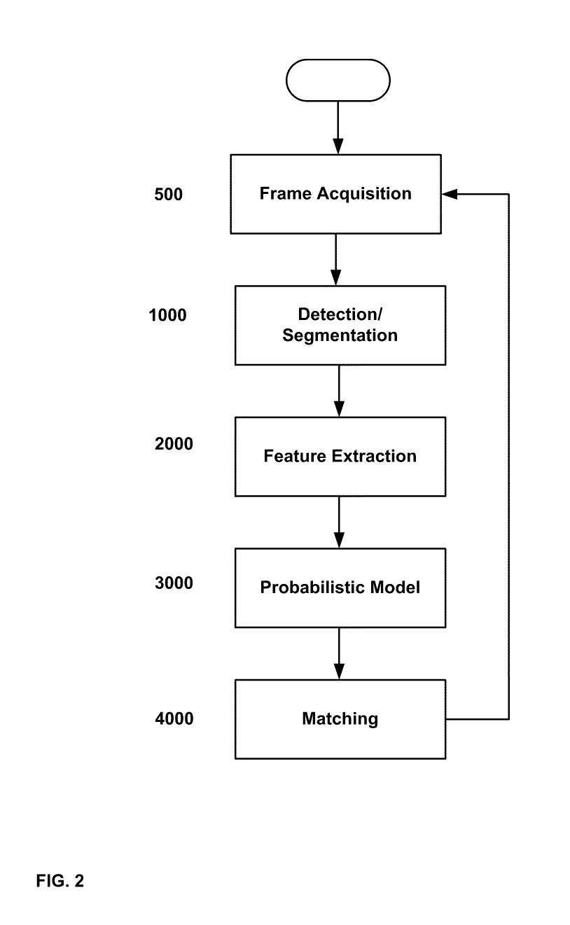

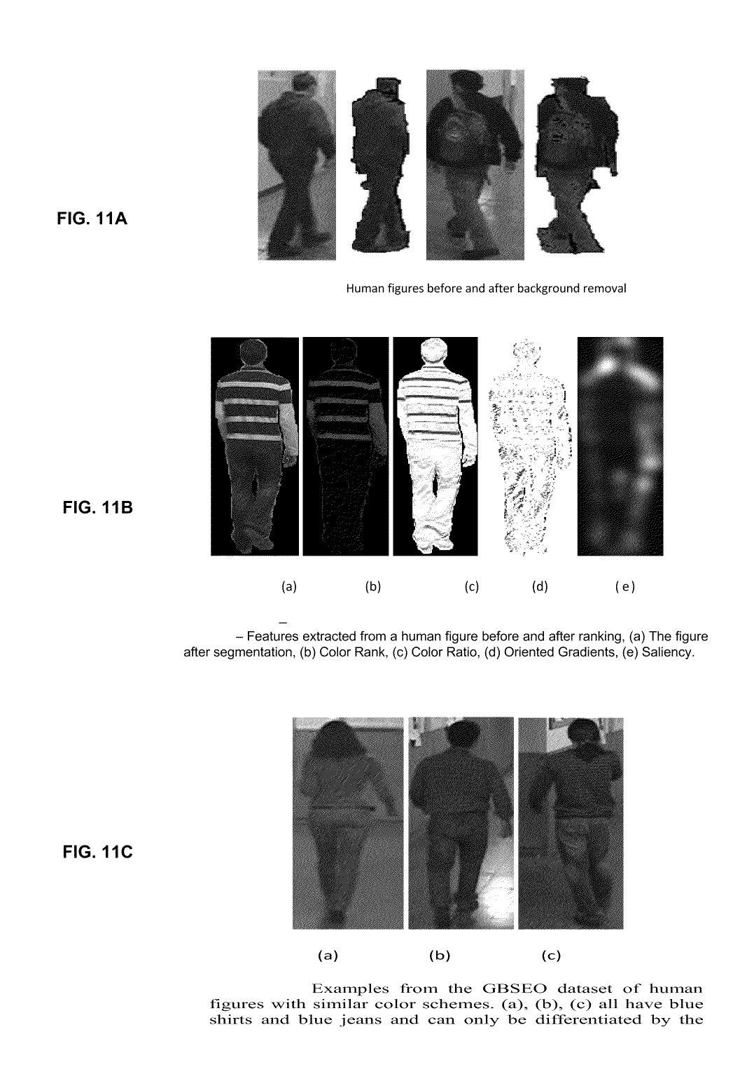

Turning now to FIG. 1A, there is shown a block diagram of an exemplary system for correlating or matching an object or person (e.g. subject of interest) present within two or more images, in accordance with some embodiments of the present invention. Operation of the system of FIG. 1A may be described in conjunction with the flow chart of FIG. 2, which shows steps performed by an exemplary system for correlating/matching an object or person present within two or more images in accordance with some embodiments of the present invention. The operation of the system of FIG. 1A may further be described in view of the images shown in FIGS. 11A through 11C, wherein FIG. 11A is a set of image frames containing human subject, before and after a background removal process, in accordance with some embodiments of the present invention. FIG. 11B is a set of image frames showing images containing human subjects after: (a) a segmentation process; (b) a color ranking process; (c) a color ratio extraction process; (d) a gradient orientation process; and (e) a saliency maps ranking process, in accordance with some embodiments of the present invention. And, FIG. 11C is a set of image frames showing human subjects having similar color schemes but which may be differentiated by their shirts' patterns in accordance with some texture matching embodiments of the present invention.

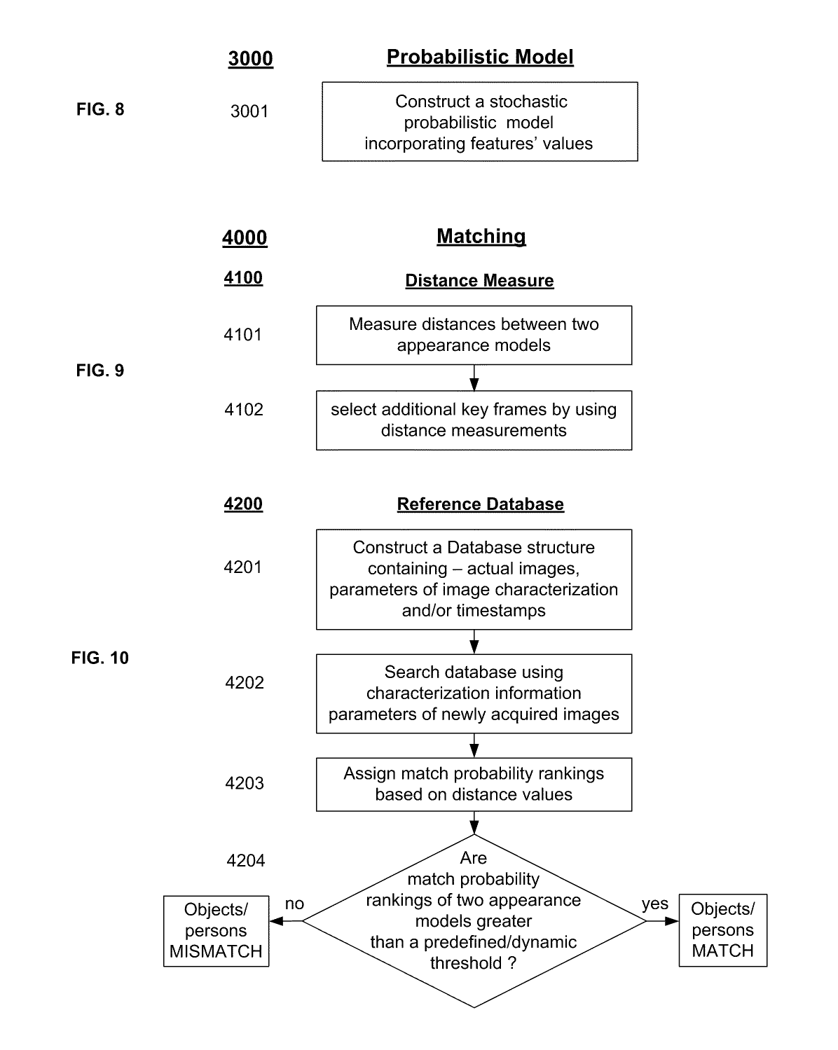

Turning back to FIG. 1A, there is a functional block diagram which shows images being supplied/acquired (step 500) by each of multiple (e.g. video) cameras positioned at various locations within a facility or building. The images contain one or a set of people. The images are first segmented (step 1000) around the people using a detection and segmentation block. Features relating to the subjects of the segmented images are extracted (step 2000) and optionally ranked/normalized by an extraction & ranking/normalization block. The extracted features and optionally the original (segmented) images may be stored in a functionally associated database (e.g. implemented in mass storage, cache, etc.). A matching block may compare (step 3000) newly acquired image feature associated with a newly acquired subject containing image with features stored in the database in order to determine a linkage, correlation and/or matching between subjects appearing in two or more images acquired from different cameras. Optionally, either the extraction block or the matching may apply or construct a probabilistic model to or based on the extracted feature (FIG. 8—step 3001). The matching system may provide information about a detected/suspected match to a surveillance or recording system.

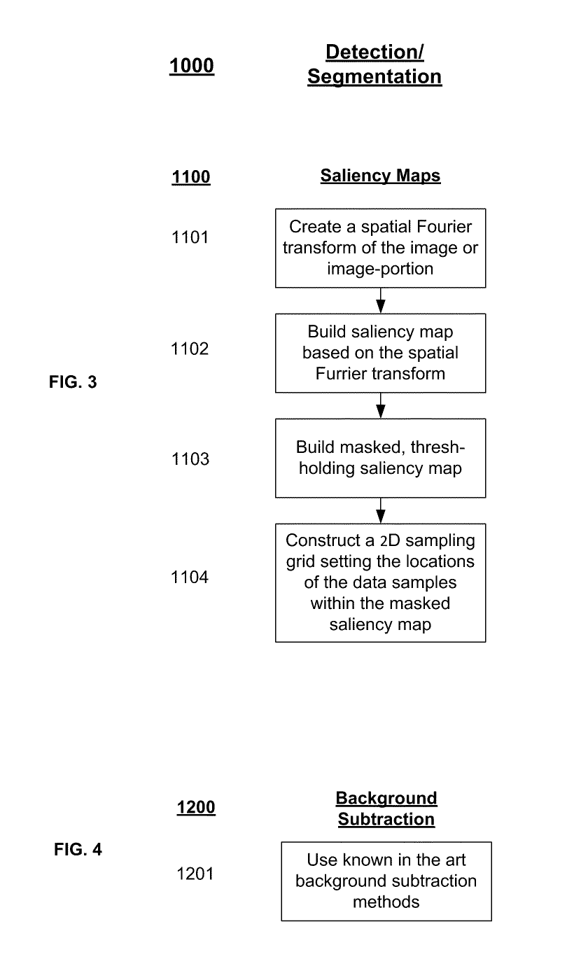

Various exemplary Detection/Segmentations techniques may be used in conjunction with the present invention. FIGS. 3, 4 provide examples of two such methods. FIG. 3 is a flow chart showing steps of an exemplary saliency map generation process which may be performed as part of Detection and/or Segmentation in accordance with some embodiments of the present invention. While FIG. 4 is a flow chart showing steps of an exemplary background subtraction process which may be performed as part of Detection and/or Segmentation in accordance with some embodiments of the present invention

Turning now to FIG. 1B, there is shown a block diagram of an exemplary Image Feature Extraction & Ranking/Normalization Block in accordance with some embodiments of the present invention. The feature extraction block may include a color feature extraction module, which may perform color ranking, color normalization, or both. Also included in the block may be a textural-color feature module which may determine ranked color ratios, ranked orientation gradients, ranked saliency maps, or any combination of the three. A height feature module may determine a normalized pixel height of one or more pixel sets within an image segment. Each of the extraction related modules may function individually or in combination with each of the other modules. The output of the extraction block may be one or a set of (vector) characterization parameters for one or set of features related to a subject found in an image segment.

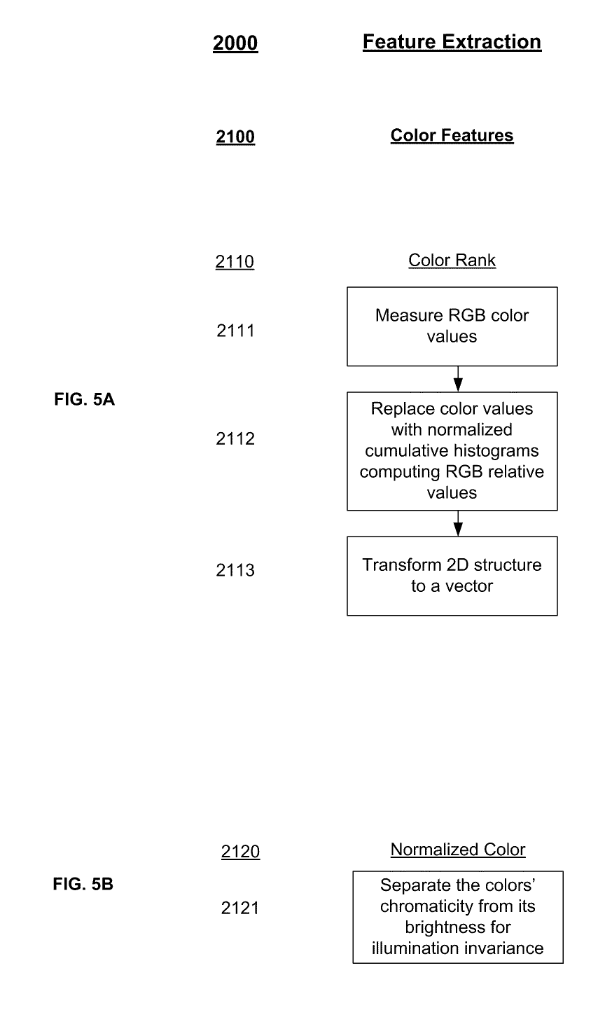

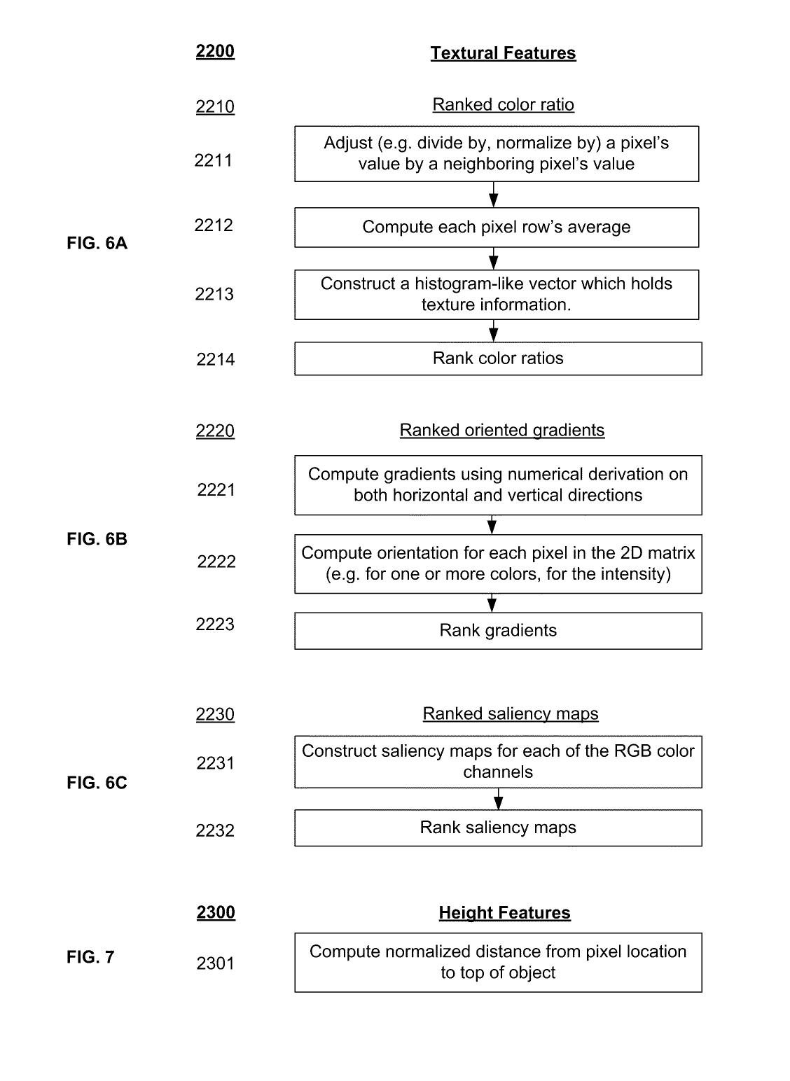

Exemplary steps processing steps performed by each of the modules shown in FIG. 1B are listed in FIGS. 5 through 7, where FIG. 5 shows a flow chart including the steps of an exemplary color ranking process which may be performed as part of color features extraction in accordance with some embodiments of the present invention. FIG. 6A shows a flow chart including the steps of an exemplary color ratio ranking process which may be performed as part of a textural features extraction in accordance with some embodiments of the present invention. FIG. 6B shows a flow chart including the steps of an exemplary oriented gradients ranking process which may be performed as part of a textural features extraction in accordance with some embodiments of the present invention. FIG. 6C is a flow chart including the steps of an exemplary saliency maps ranking process which may be performed as part of textural features extraction in accordance with some embodiments of the present invention. And, FIG. 7 shows a flow chart including steps of an exemplary height features extraction process which may be performed as part of textural features extraction in accordance with some embodiments of the present invention.

Turning now to FIG. 1C, there is shown a block diagram of an exemplary Matching Block in accordance with some embodiments of the present invention. Operation of the matching block may be performed according to the exemplary method depicted in the flowcharts of FIGS. 9 and 10, where FIG. 9 is a flow chart showing steps of an exemplary distance measuring process which may be performed as part of feature matching in accordance with some embodiments of the present invention. FIG. 10 shows a flow chart showing steps of an exemplary database referencing and matching decision process which may be performed as part of feature and/or subject matching in accordance with some embodiments of the present invention. The matching block may include a characterization parameter distance measuring probabilistic module adapted to calculate or estimate a probable correlation/match value between one or more corresponding extracted features from two separate images (steps 4101 and 4102). The matching may be performed between corresponding features of two newly acquired images or between a feature of a newly acquired image against a feature of an image stored in a functionally associated database. A match decision module may decide whether there is a match between two compared features or two compared feature sets based on either predetermined or dynamically set thresholds (steps 4201 through 4204). Alternatively, the match decision module may apply a best fit or closest match rule.

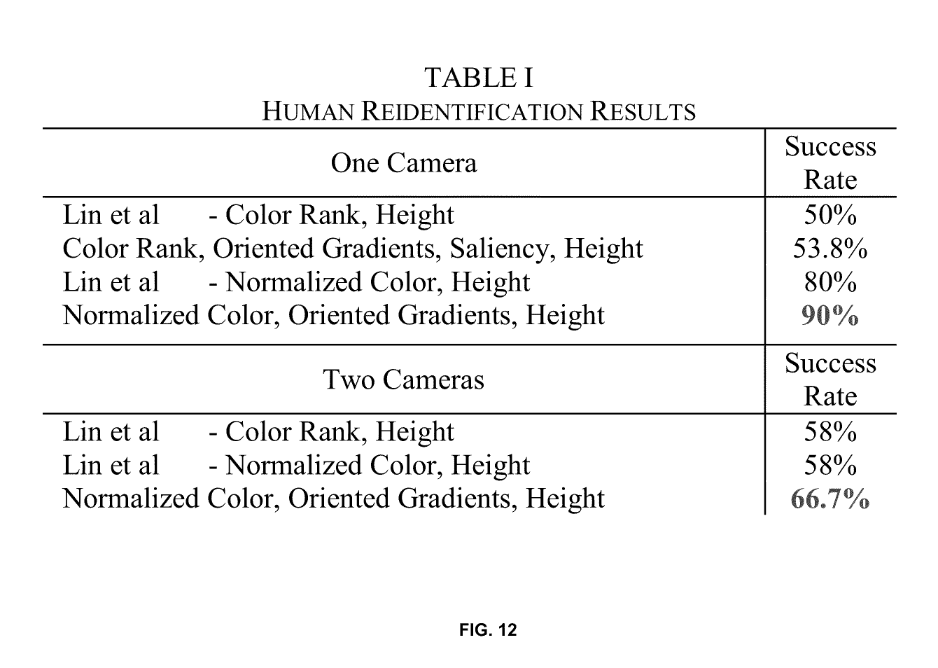

FIG. 12 is a table comparing exemplary human reidentification success rate results between exemplary reidentification methods of the present invention and those taught by Lin et al., when using one or two cameras, and in accordance with some embodiments of the present invention. Significantly better results were achieved using the techniques, methods and processes of the present invention.

Various aspects and embodiments of the present invention will now be described with reference to specific exemplary formulas which may optionally be used to implement some embodiments of the present invention. However, it should be understood that any functionally equivalent formulas, whether known today or to be devised in the future may also be applicable. Certain portions of the below description are made with reference to teachings provided in publications previously listed within this application and using the reference numbers assigned to the publications in the listing.

The present invention is a method, circuit and system for correlating an object or person present (i.e. visible within) within two or more images. According to some embodiments of the present invention, an object or person present within a first image or a first series of images (e.g. a video sequence) may be characterized and the characterization information (i.e. one or a set of parameters) relating to the person or object may be stored in a database, random access memory or cache for subsequent comparison to characterization information derived from other images. Database may also be distributed over the net of storage locations.

According to some embodiments of the present invention, characterization of objects/persons found within an image may be performed in two stages: (1) segmentation, and (2) feature extraction.

According to some embodiments of the present invention, Segmentation may be performed using any technique known today or to be devised in the future. According to some embodiments Background Subtraction Techniques (e.g. using a reference image) or other object detection techniques without reference image, [12] (e.g. Viola and Jones) may be used for initial, rough segmentation of objects. Another technique, which may also be used as a refinement technique, may include the use of a saliency map(s) of the object/person [11]. There are several ways in which saliency maps may be extracted.

According to some embodiments of the present invention, saliency mapping may include transformation of the image I(x,y) to the frequency and phase domain, A(kx,ky) exp(jΦ(kx,ky)=F{I(x,y)}. F indicates the 2-D spatial Fourier transform, where A and Φ is the amplitude and the phase of the transformation, respectively. The saliency maps are obtained as S(x,y)=g*|F−1{1/A exp(jΦ)}|̂2. Where F−1 indicates the inverse of the 2-D spatial Fourier transform, g is a 2D Gaussian function, ∥ and * indicates absolute value and convolution, respectively. According to further embodiments of the present invention, saliency maps may be else wise obtained (e.g. as S(x,y)=g*|F−1{exp(jΦ)}|̂2 (Guo C. et at, 2008)).

According to some embodiments of the present invention, moving from saliency maps to segmentation may involve masking—applying a threshold over the saliency maps. Pixels with saliency values greater or equal to the threshold may be considered part of the human figure, whereas pixels with saliency values lesser than the threshold may be considered part of the background. Thresholds may be set to give satisfactory results for the type(s) of filters being used (e.g. the mean of the saliency intensities for a Gaussian filter).

According to some embodiments of the present invention, a 2D sampling grid may be used to set the locations of the data samples within the masked saliency maps. According to some embodiments of the present invention a fixed number of samples may be allocated and distributed along the columns (vertical).

According to some embodiments of the present invention, various characteristics such as color, textural and spatial features may be extracted from the segmented object/person. According to some embodiments of the present invention, features may be extracted for comparison between objects. Features may be made compact for storage efficiency (e.g. Mean Color, Most Common Color, 15 Major Colors). While some features such as color histogram and oriented gradients histogram may contain probabilistic information, others may contain spatial information.

According to some embodiments of the present invention, certain considerations may be made when choosing the features to be extracted from the segmented object. Such considerations may include: the discriminative nature and the separability of the feature, the robustness to illumination changes when dealing with multiple cameras and dynamic environments, and, noise robustness and scale invariance.

According to some embodiments of the present invention, scale invariance may be achieved by resizing each figure to a constant size. Robustness to illumination changes may be achieved using a method of ranking over the features, mapping absolute values to relative values. Ranking may cancel any linear modeled lighting transformations, under the assumption that for such transformations the shape of the feature distribution function is relatively constant. According to some embodiments, in order to obtain the rank of a vector x, the normalized cumulative histogram H(x) of the vector is calculated. The rank O(x) may accordingly be given by [9]:

O(x)=┌H(x)·100┐

Where [symbol] denotes rounding the number up to the consecutive integer. For example, using 100 as a factor sets the possible values of the ranked feature to [x] and sets the values of O(x) to the percentage values of the cumulative histogram. The proposed ranking method may be applied on the chosen features to achieve robustness to linear illumination changes.

According to some embodiments of the present invention, color rank features [13] may be used. Color rank values may be obtained by applying the ranking process on the RGB color channels using the O(x)=┌H(x)·100┐ equation. Another color feature is the normalized color [13], this feature's values are obtained using the following color transformation:

$$( r , g , s ) = ( \frac{R}{( R + G + B )} , \frac{G}{( R + G + B )} , \frac{( R + G + B )}{3} )$$

Where R, G and B denote the red, green and blue color channels of the segmented object, respectively. r and g denote the chromaticity of the red and green channel respectively and s denotes the brightness. Transforming to the ‘rgs’ color space may separate the chromaticity from the brightness resulting in illumination invariance.

According to some embodiments of the present invention, each color component R, G, and B may be ranked to obtained robustness, to monotonic color transformations and illumination changes. According to some embodiments ranking may transform absolute values into relative values by replacing a given color value c by H(c), where H(c) is the normalized cumulative histogram for the color c. Quantization of H(c) to a fixed number of levels may be used. A transformation from the 2D structure into a vector may be obtained by raster scanning (e.g. from left to right and top to bottom). The number of vector elements may be fixed. According to some exemplary embodiments of the present invention the number of elements may be 500 and the number of quantization levels for H( ) may be 100.

According to some embodiments of the present invention, when dealing with similarly colored objects or with figures with similar clothing colors (e.g. a red and white striped shirt compared with a red and white shirt with a crisscross pattern) color ranking may be insufficient. Textural features, on the other hand, may obtain values in relation to their spatial surroundings as Information is extracted from a region rather than a single pixel and thus a more global point of view is obtained.

According to some embodiments of the present invention, a ranked color ratio feature, in which each pixel is divided by its neighbor (e.g. upper), may be obtained. This feature is derived from a multiplicative model of light and a principle of locality. This operation may intensify edges and may separate them from the plain regions of the object. For a more compact representation, as well as rotational invariance around the vertical axis, an average may be calculated over each row. This may result in a column vector corresponding to the spatial location of each value. Finally, the resulting vector or matrix may be ranked by applying the O(x)=┌H(x)·100┐ equation.

According to some embodiments of the present invention, ranked color ratio may be a textural descriptor based on a multiplicative model of light and noise, wherein each pixel value is divided by one or more neighboring (e.g. upper) pixel values. The image may be resized in order to achieve scale invariance. Furthermore, every row, or every row out of a subset of rows, may be averaged in order to achieve some rotational invariance. According to some embodiments of the present invention, one color component may be use, say green (G). G ratio values may be ranked as described hereinbefore. The resulting output may be a histogram-like vector which holds texture information and is somewhat invariant to light, scale and rotation.

According to some embodiments of the present invention, Oriented Gradients Rank may be computed using numerical derivation on both horizontal (dx) and vertical (dy) directions. The ranking of orientation angles may be executed as described hereinbefore. According to some embodiments of the present invention, the Ranked Oriented Gradients may be based on a Histogram of Oriented Gradients [14]. According to some embodiments, a 1-D centered mask may initially be applied (e.g. −1,0,1) on both horizontal and vertical directions.

According to some embodiments of the present invention, gradients may be calculated on both the horizontal and the vertical directions. The gradient's orientation of each pixel [symbol] , may be calculated using:

$${θ}_{( i , j )} = arctan ( \frac{{dy}_{( i , j )}}{{dx}_{( i , j )}} )$$

Where [symbol] is the vertical gradient and [symbol] is the horizontal gradient in pixel [symbol] . Instead of using a histogram, the matrix form may be kept in order to maintain spatial information regarding the location of each value. Then, ranking may be performed using the O(x)=┌H(x)·100┐ equation for quantization.

According to some embodiments of the present invention, Ranked Saliency Maps, may be obtained by extracting one or more textual features where a textual feature may be extracted from a saliency map S(x,y) (e.g. the map described hereinbefore). The values of S(x,y) may be ranked and quantized.

According to some embodiments of the present invention, a saliency map sM may be obtained, for each of the RGB color channels by [11]:

φ(u,v)=∠F(I(x,y))

A(u,v)=|F(I(x,y))|

sM(x,y)=g(x,y)*|F⁻¹[A⁻¹(u,v)·e^{j·φ(u,v)}]|²

Where F(·) and F⁻¹(·) denote the Fourier Transform and Inverse Fourier Transform, respectively. A(u,v) represents the magnitude of the color channel I(x,y), [symbol] represents the phase spectrum of I(x,y) and g(x,y) is a filter (e.g. a 8×8 Gaussian filter). Each of the saliency maps may then be ranked using the O(x)=┌H(x)·100┐ equation.

According to some embodiments of the present invention, in order to represent the aforementioned features in a structural context, spatial information may be stored by using a height feature. The height feature may be calculated using the normalized y-coordinate of the pixel, wherein the normalization may ensure scale invariance, using the normalized distance from the location of the pixel on the grid of data samples to the top of the object. The normalization may be done with respect to the object's height.

According to some embodiments of the present invention, Robustness To Rotation may be obtained by storing one or more sequences of snapshots rather than single snapshots. For efficiency of computation and storage constraints only few key frames may be saved for each person. A new key frame may be selected when the information carried by the feature vectors of the snapshot is different from the one carried by the previous key frame(s). Substantially the same distance measure which is used to match between two objects may be used for the selection of an additional key frame. According to one exemplary embodiment of the present invention, 7 vectors, each of size 1×500 elements, may be stored for each snapshot.

According to some embodiments of the present invention, one or more parameters of the characterization information may be indexed in the database for ease of future search and/or comparison. According to further embodiments of the present invention, the actual image(s) from which the characterization information is extracted may also be stored in the database or in an associated database. Accordingly, a reference database of imaged objects or people may be compiled. According to some embodiments of the present invention, database records containing the characterization parameters may be recorded and permanently maintained. According to further embodiments of the present invention, such records may be time-stamped and may expire after some period of time. According to even further embodiments of the present invention, the database may be stored in a random access memory or cache used by a video based object/person tracking system employing multiple cameras having different fields of view.

According to some embodiments of the present invention, newly acquired image(s) may be similarly processed to those associated with database records, wherein objects and people present in the newly acquired images may be characterized, and the parameters of the characterization information from the new image(s) may be compared with records in the database. One or more parameters of the characterization information from objects/people in the newly acquired image(s) may be used as part of a search query in the database, memory or cache.

According to some embodiments of the present invention, the features' values of each pixel may be represented in an n-dimensional vector where n denotes the number of features extracted from the image. Feature values for a given person or object may not be deterministic and may accordingly vary among frames. Hence, a stochastic model which incorporates the different features may be used. For example, multivariate kernel density estimation (MKDE) [10] may be used to construct the probabilistic model [9], wherein, given a set of feature vectors {sᵢ}:

$${s}_{i} = {( {s}_{i 1} , … , {s}_{in} )}^{T} , i = 1 … {N}_{p}$$

$$\hat{p} ( z ) = \frac{1}{{N}_{p} {σ}_{1} \cdot … {σ}_{n}} {\sum }_{i = 1}^{{N}_{p}} {\prod }_{j = 1}^{n} κ ( \frac{{z}_{j} - {s}_{ij}}{{σ}_{j}} )$$

Where [symbol] is the probability of obtaining a given feature vector z with the same components as [symbol] denotes the Gaussian kernel, which is the kernel function used for all channels. [symbol] is the number of pixels sampled from a given object and [symbol] are parameters denoting the standard deviation of the kernels which may be set according to empirical results.

According to some embodiments of the present invention, matching or correlating the same objects/people found in two or more images may be achieved by matching characterization parameters of the objects/people extracted from each of the two or more images. Each of a wide variety of parameter(s) (i.e. data set) matching algorithms may be utilized as part of the present invention.

According to some embodiments of the present invention, the parameters may be stored in the form of a multidimensional (multi-parameter) vector or dataset/matrix. Comparisons between two sets of characterization parameters may thus require algorithms which calculate, estimate and/or otherwise derive multidimensional distance values between two multidimensional vectors or datasets. According to further embodiments of the present invention, the Kullback-Leibler (KL) [15] may be used to match two appearances models.

According to some embodiments of the present invention, a distance between the characterization parameter set of an object/person found in an acquired image and each of multiple characterization sets stored in a database may be calculated when attempting to correlate the object/person with previously imaged objects/people. The distance values from each comparison may be used to assign one or more rankings for probability of a match between objects/people. According to some embodiments of the present invention, the shorter the distance is, the higher the ranking may be. According to some embodiments of the present invention, a ranking resulting from a comparison of two object/person images having a value above some predefined or dynamically selected threshold may be designated as a “match” between the objects/persons found in the two images.

According to some embodiments of the present invention, In order to evaluate the correlation between two appearance models, a distance measure may be defined. One exemplary such distance measure may be the Kullback-Leibler distance [15] denoted as [symbol] . The Kullback-Leibler distance, may quantify the difference between two probabilistic density functions:

$${D}_{KL} ( {\hat{p}}^{A} \vert {\hat{p}}^{B} ) = \int {\hat{p}}^{B} ( z ) \cdot log \frac{{\hat{p}}^{B} ( z )}{{\hat{p}}^{A} ( z )} d z$$

Where [symbol] and [symbol] denote the probability to obtain the feature value vector z for appearance model B and A respectively. A transformation into a discrete analysis may then be performed using known in the art methods (e.g. [9]). Appearance models from a dataset may be compared with a new model using the Kullback-Leibler distance measure. Low [symbol] values may represent small information gains corresponding to a match of appearance models based on a nearest neighbor approach.

According to some embodiments of the present invention, the robustness of the appearance model may be improved by matching key frames from the trajectory path of the object, rather than matching a single image. Key frames may be selected (e.g. using the Kullback-Leibler distance) along the trajectory path. The distance between two trajectories [symbol] may be obtained using:

$${L}^{( I , J )} = {median}_{i ∈ {K}^{( I )}} [ {min}_{j ∈ {K}^{( J )}} {D}_{KL} ( {p}_{i}^{( I )} \vert {p}_{j}^{( J )} ) ]$$

Where [symbol] and [symbol] denote the set of key frames from the trajectories [symbol] and [symbol] respectively. [symbol] denotes the probability density function based on a key frame [symbol] from trajectory [symbol] . First, for each key-frame [symbol] in trajectory [symbol] the distance from trajectory [symbol] is found. Then, in order to remove outliers produced by segmentation errors or object entrance/exit in the scene, a statistical index (e.g. the median) of all distances may be calculated and its results utilized.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. An image subject matching system comprising:
a feature extraction block for extracting one or more features associated with each of one or more subjects in a first image frame, wherein feature extraction includes at least one ranked oriented gradient.

2. The system according to claim 1, wherein the ranked oriented gradient is computed using numerical derivation in a horizontal direction.

3. The system according to claim 1, wherein the ranked oriented gradient is computed using numerical derivation in a vertical direction.

4. The system according to claim 1, wherein the ranked oriented gradient is computed using numerical derivation in both horizontal and vertical directions.

5. The system according to claim 1, wherein the ranked oriented gradient is associated with a normalized height.

6. The system according to claim 5, wherein the ranked oriented gradient of the image feature is compared against a ranked oriented gradient of a feature in a second image.

7. An image subject matching system comprising:
a feature extraction block for extracting one or more features associated with each of one or more subjects in a first image frame, wherein feature extraction includes computing at least one ranked color ratio vector.

8. The image processing system according to claim 7, wherein the vector is computed using numerical processing along a horizontal direction.

9. The image processing system according to claim 7, wherein the vector is computed using numerical processing along a vertical direction.

10. The image processing system according to claim 7, wherein the vector is computed using numerical processing along both horizontal and vertical directions.

11. The system according to claim 7, wherein the vector is associated with a normalized height.

12. The system according to claim 11, wherein the vector of the image feature is compared against a vector of a feature in a second image.

13. An image subject matching system comprising:
an object detection or an image segmentation block for segmenting an image into one or more segments containing a subject of interest, wherein the object detection or the image segmentation includes generating at least one saliency map.

14. The system according to claim 13, wherein the saliency map is a ranked saliency map.
